(19) United States
(12) Patent Application Publication
(10) Pub. No.: US 2013/0328659 A1
(43) Pub. Date: Dec. 12, 2013

(54) Sealed Thermostat

(71) Applicants: David L. Hall, South Salt Lake, UT (US); Arthur J. Fillion, Ogden, UT (US); Aaron G. Evans, Queen Creek, AZ (US); Bradley G. Terry, St. Georga, UT (US)

(72) Inventors: David L. Hall, South Salt Lake, UT (US); Arthur J. Fillion, Ogden, UT (US); Aaron G. Evans, Queen Creek, AZ (US); Bradley G. Terry, St. Georga, UT (US)

(21) Appl. No.: 13/901,438

(22) Filed: May 23, 2013

Related U.S. Application Data
(60) Provisional application No. 61/657,610, filed on Jun. 8, 2012.

(51) Int. Cl. H01H 37/54

(52) U.S. Cl. CPC H01H 37/5427
USPC 337/380; 277/314

(57) ABSTRACT

A sealed thermostat includes a body, electrical leads extending from the body for electrically connecting the thermostat to a system, a sheath sized to encapsulate the body and having a wall terminating at an open end, the sheath being disposed around the body with at least one of the electrical leads extending from the open end, and a sealant disposed in the open end around at least one electrical lead and between at least one electrical lead and the wall, thereby sealing the body within the sheath. The sealant and sheath substantially completely isolate the body from gasses capable of being ignited by an arc within the body.

### CROSS-REFERENCE TO RELATED APPLICATIONS

This application claims the benefit of U.S. Provisional Patent Application No. 61/657,610 which was filed on Jun. 8, 2012.

### BACKGROUND OF THE INVENTION

1. Field of the Invention

The present invention relates to thermostats, and more particularly to sealed thermostats such as those for use in hazardous environments.

2. Background and Related Art

Thermostats are generally used for temperature-dependent control of electrical systems. Electric control thermostats may operate to simply make or break an electrical connection at one or more desired temperatures. Alternatively, more complex electric control thermostats may operate not only to make or break an electrical connection, but may also operate to modify an electrical connection, such as to modify an amount of current passed by an electric connection controlled by the thermostat. Thermostats are used in a wide variety of systems and situations and a wide variety of types of thermostats are available for use in varying applications.

The type of thermostat chosen for use in a particular application may vary based on a variety of considerations, and certain types of thermostats have certain limitations. For example, the thermostat chosen may be chosen based on cost, intended use, desired specificity, location of intended use, and a variety of other factors. For example, some thermostats use a mercury switch to make and break an electrical contact. In such a thermostat, temperature-dependent elements cause the mercury switch to tilt, causing the mercury inside the switch to flow until it connects or disconnects electrical contacts. Because thermostats incorporating a mercury switch are dependent on tilting of the mercury switch, such thermostats are typically only used in situations where the thermostat will be fixed and not subject to tilting or movement that could adversely affect thermostat function.

One commonly-used and inexpensive type of thermostat is a bi-metallic strip thermostat. This type of thermostat senses temperature using the differential expansion of two metals to actuate an on/off switch. Typically, the system would be switched on when the temperature drops below the set point on the thermostat, and switched off when it rises above, with a few degrees of hysteresis to prevent excessive switching. Such thermostat switches are inexpensive and reliable, but can be difficult to use in certain situations. The movement of the bi-metallic strip to actuate the on/off switch causes an electrical arc to occur at the switch contacts at every on actuation and at every off actuation. Thus, unless precautions are taken to isolate the arc, such switches cannot be used in situations where electrical arcs could lead to ignition of combustible materials. Similar difficulties are inherent with any type of thermostat in which electrical arcs occur.

Efforts have been made to hermetically seal thermostats so that the thermostats can be used in such hazardous environments, with varying levels of success. One difficulty in hermetically sealing thermostats is that combustible materials are often in gaseous form, so the hermetic sealing must prevent external gases from reaching the arc. As a result, the efforts at hermetically sealing thermostats have generally resulted in thermostats that have a significantly higher cost than non-sealed thermostats. For example, while a standard (non-sealed) thermostat otherwise suitable for a particular application might cost at most a few dollars, its hermetically sealed counterpart might cost tens to more than a hundred dollars.

In some instances where thermostats are to be used, the thermostats may be subject to significant physical abuses, such as impacts, pressures, torques, and the like. Any hermetically sealed thermostat that is to be used in locations where the presence of an arc would be hazardous must be able to maintain its hermetic sealing after being subject to an expected lifetime of abuse. As may be appreciated, even a single failure of a hermetic sealing could be extremely hazardous. Many existing methods for providing hermetically sealed thermostats do not adequately take into account such physical abuses, limiting the uses of existing hermetically sealed thermostats.

### BRIEF SUMMARY OF THE INVENTION

Implementation of the invention provides a sealed thermostat. The thermostat includes a body, electrical leads extending from the body for electrically connecting the thermostat to a system, a sheath sized to encapsulate the body and having a wall terminating at an open end, the sheath being disposed around the body with at least one of the electrical leads extending from the open end, and a sealant disposed in the open end around at least one electrical lead and between at least one electrical lead and the wall, thereby sealing the body within the sheath. The sealant and sheath substantially completely isolate the body from gasses capable of being ignited by an arc within the body.

The open end of the sheath may be one of two open ends of the sheath, with both open ends being sealed by the sealant. The sheath may be formed in a flexible, substantially cylindrical form defined by the wall. If two open ends are present on the sheath, the electrical leads either all extend from a single open end of the sheath or extend through both open ends of the sheath. The sheath wall may be seamless between the open ends.

The sheath may be sized to snugly contain the body to facilitate heat transfer between an environment outside the sheath and the body. The sleeve may be formed of or include biaxially-oriented polyethylene terephthalate. The sealant may be formed of or include a silicone-based sealant and a silicone-containing sealant and may be an adhesive sealant. The body may contain a shunted bimetallic element, a conductive bimetallic element, or any other temperature-dependent element configured to control the thermostat.

Implementation of the invention also provides a method for sealing a thermostat having a body with electrical leads for electrically connecting the thermostat to a system extending therefrom. The method includes disposing the body in a sheath sized to encapsulate the body and having a wall terminating at an open end with at least one of the electrical leads extending from the open end and filling the open end around at least one electrical lead and between at least one electrical lead and the wall with a sealant, thereby sealing the body within the sheath.

The method may also include curing the sealant, inspecting the sealant after curing to detect any holes or voids in the sealant, and sizing the sleeve to substantially snugly receive the body. In some implementations, the open end of the sheath is one of two open ends of the sheath, and filling the open end with the sealant involves filling both open ends of the sheath with the sealant.

When the open end is filled with sealant, it is ensured that the sealant completely closes the open end around any electrical leads within the open end. This may involve ensuring that sealant fills all locations of the open end with at least a minimum thickness of the sealant.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative thermostat;

FIG. 2 shows a representative thermostat encapsulated in a sheath; and

FIG. 3 shows a representative thermostat encapsulated in a sheath sealed with a sealant.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide a sealed thermostat. The thermostat includes a body, electrical leads extending from the body for electrically connecting the thermostat to a system, a sheath sized to encapsulate the body and having a wall terminating at an open end, the sheath being disposed around the body with at least one of the electrical leads extending from the open end, and a sealant disposed in the open end around at least one electrical lead and between at least one electrical lead and the wall, thereby sealing the body within the sheath. The sealant and sheath substantially completely isolate the body from gasses capable of being ignited by an arc within the body.

The open end of the sheath may be one of two open ends of the sheath, with both open ends being sealed by the sealant. The sheath may be formed in a flexible, substantially cylindrical form defined by the wall. If two open ends are present on the sheath, the electrical leads either all extend from a single open end of the sheath or extend through both open ends of the sheath. The sheath wall may be seamless between the open ends.

The sheath may be sized to snugly contain the body to facilitate heat transfer between an environment outside the sheath and the body. The sleeve may be formed of or include biaxially-oriented polyethylene terephthalate. The sealant may be formed of or include a silicone-based sealant and a silicone-containing sealant and may be an adhesive sealant. The body may contain a shunted bimetallic element, a conductive bimetallic element, or any other temperature-dependent element configured to control the thermostat.

Embodiments of the invention also provide a method for sealing a thermostat having a body with electrical leads for electrically connecting the thermostat to a system extending therefrom. The method includes disposing the body in a sheath sized to encapsulate the body and having a wall terminating at an open end with at least one of the electrical leads extending from the open end and filling the open end around at least one electrical lead and between at least one electrical lead and the wall with a sealant, thereby sealing the body within the sheath.

The method may also include curing the sealant, inspecting the sealant after curing to detect any holes or voids in the sealant, and sizing the sleeve to substantially snugly receive the body. In some embodiments, the open end of the sheath is one of two open ends of the sheath, and filling the open end with the sealant involves filling both open ends of the sheath with the sealant.

When the open end is filled with sealant, it is ensured that the sealant completely closes the open end around any electrical leads within the open end. This may involve ensuring that sealant fills all locations of the open end with at least a minimum thickness of the sealant.

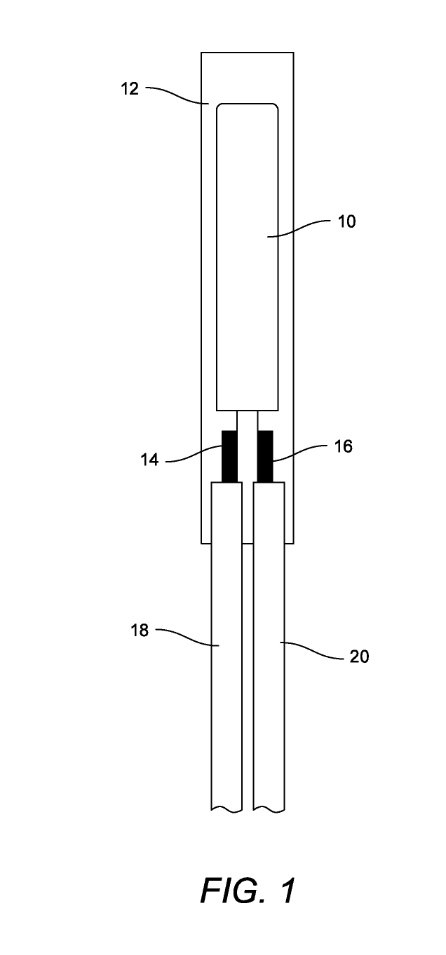

FIG. 1 illustrates features of a representative embodiment of a thermostat. The thermostat includes a body 10, the body 10 of this embodiment being encased in a housing 12. The body 10 and the housing 12 may have dimensions appropriate for the desired thermostat application. The exact dimensions of the body 10 and housing 12, and any component of the thermostat discussed herein are not critical to function of the embodiments of the invention other than that the various components are appropriately sized to properly engage and function with the other components discussed herein. Therefore, the dimensions or proportions illustrated in the Figures are intended to be illustrative of the features of the various embodiments of the invention only, and are not limiting. For purposes of facilitating the discussion herein, features illustrated in the Figures and discussed herein may be exaggerated, and the scope of the invention is not limited by any relative sizes depicted in the Figures or discussed herein.

The body 10 and/or the housing 12 include components providing standard thermostat features, namely at least temperature-dependent on and off switching of an electrical connection between a first lead 14 of the thermostat and a second lead 16 of the thermostat. The thermostat may provide the on and off switching using any appropriate known or later-invented technology for providing temperature-dependent switching. One commonly-used and inexpensive technology used for providing temperature-dependent switching is bimetallic switching, including shunted bimetallic elements and conductive bimetallic elements. Bimetallic switching is advantageous in certain circumstances as it is orientation-independent and thus suitable for a wide range of applications. As is known, switching using such technology is associated with arc formation as the electrical contact is made or broken.

An electrical arc can be hazardous when combustive or explosive gases are present. In such hazardous conditions, it is desirous to seal the location of the arc from the hazardous gases to prevent ignition of the gasses. While attempts have been made to provide sealed thermostats, such attempts have been costly and of modest effectiveness. In some instances, efforts have been made to seal the housing 12. One difficulty of sealing the housing 12 is that means must be provided for connecting the thermostat to external systems. Thus, the first lead 14 and the second lead 16 of the thermostat are connected to a first electrical lead 18 and a second electrical lead 20 (e.g. wires) that extend through and electrically communicate through the housing 12. It can be difficult and hence expensive to adequately seal the housing, especially around the first electrical lead 18 and the second electrical lead 20.

Additionally, in many instances, the thermostat may be subject to external forces that stress the housing 12 and any sealing thereof, which may lead to failure of the sealing elements. For example, the thermostat may be subject to impacts that may dent the housing 12, causing failure of the seal. If, instead, the thermostat is installed in a location where the thermostat is subject to non-impact forces that slowly stress the housing 12 and/or the seal of the housing, the seal may slowly wear out, crack, or otherwise fail to adequately seal the housing. Failure of the seal in a hazardous environment may make use of the thermostat unacceptable.

For example, in the oil and gas industry, it may be desirable to permit selective temperature-dependent heating of pipes used to transport oil or gas from one location to another and containers storing oil or gas, such as to permit proper flowing of the oil or gas. Systems such as heating wires, heating blankets, and other similar devices may be used to heat such pipes and containers. The heating wires, heating blankets, or other devices may be subject to flexing, stretching, and impacts as the devices are applied to the pipes or containers, are removed from the pipes or containers, or even just in normal use, such as from human, animal, or machine contact. If the thermostat and its hermetic sealing is unable to stand up to such use, the heating device that was originally “safe” to use in this environment may, over time, become dangerous to use. Therefore, existing sealed thermostats have significant limitations.

Embodiments of the invention, therefore, utilize an inexpensive thermostat such as illustrated in FIG. 1, and provide an independent, durable, and simple sealing that functions at a wide range of temperatures and continues to function regardless of significant amounts of abuse, thereby providing better separation of the thermostat's electrical arc and any hazardous gasses. This permits use of the thermostat in hazardous situations where other thermostats could not be used.

Because sealing according to embodiments of the invention is functional with essentially any standard thermostat, functional characteristics of the thermostat may be chosen based on available thermostats, and then sealing may be provided according to the principles discussed below. For example, any of a variety of thermostats such as those available from Portage Electric Products, Inc. of North Canton, Ohio (Pepi thermostats) might be used. Pepi Model B and Pepi Model W030 are a few examples of inexpensive thermostats that may be sealed as discussed below.

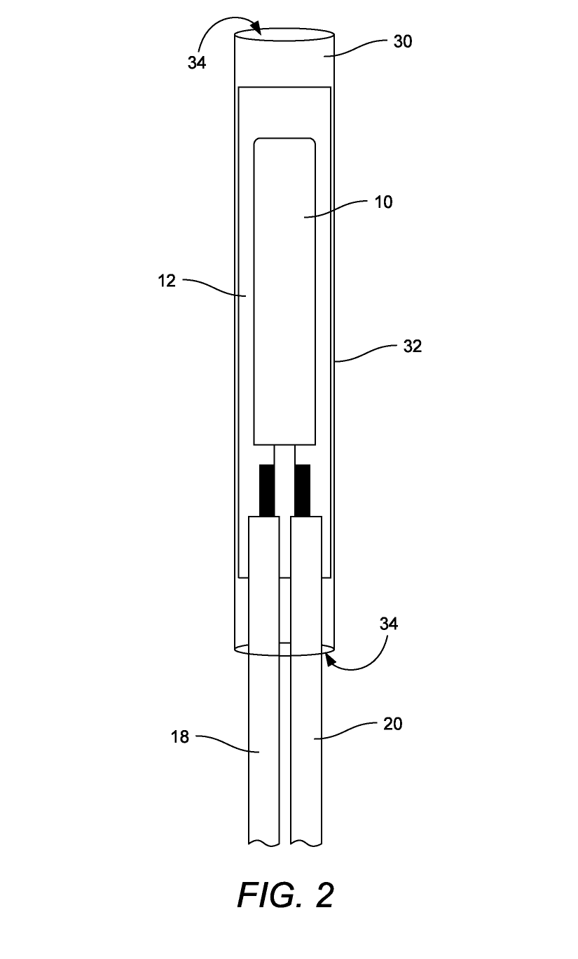

The sealing of the thermostat is provided by encapsulating the thermostat body 10 and/or housing 12 in a sheath 30 as is shown in FIG. 2. The sheath 30 illustrated in FIG. 2 is formed of any appropriate material and is formed with a wall 32 that terminates at either end at an open end 34. The sheath 30 is disposed about the thermostat such that the first electrical lead 18 and the second electrical lead 20 extend through at least one of the open ends 34. In the illustrated example, the first electrical lead 18 and the second electrical lead 20 extend through the same open end 34, but the first electrical lead 18 and the second electrical lead 20 may extend through opposite open ends 34 without affecting performance of the seal.

The sheath 30 may be formed of any appropriate gas-impermeable material. To reduce the possibility of leaking of the sheath 30, the sheath may be formed as a seamless, cylindrical tube. One possible material for the sheath 30 is biaxially-oriented polyethylene terephthalate (commonly known as Mylar), which may optionally be modified with additives or coatings as desired to modify the characteristics of the sheath 30. Other appropriate materials may be used as desired. As is seen in FIG. 2, the sheath 30 may be dimensioned so as to snugly receive the body 10 and/or the housing 12. A snug fit may facilitate heat transfer between an environment outside the sheath 30 and the body 10.

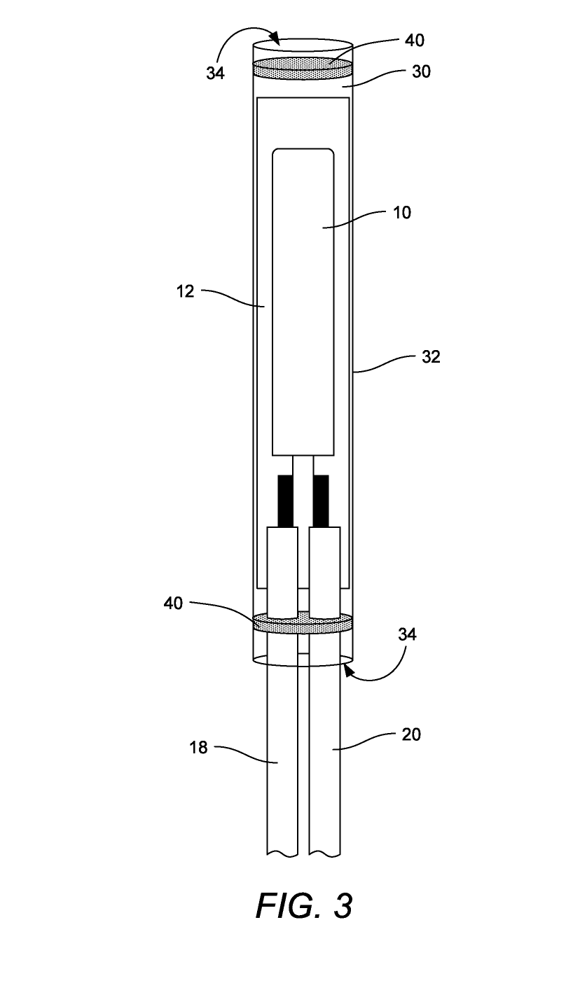

The sheath 30 is the first component that provides sealing of the thermostat, but it is necessary to seal the open ends 34 of the sheath 30, including around the first electrical lead 18 and the second electrical lead 20. This is achieved by filling the open ends 34 of the sheath 30 with a sealant 40 as is illustrated in FIG. 3. The size and location of the sealant 40 shown in FIG. 3 is provided only to illustrate the concepts of the embodiments of the invention. The sealant 40 may fill substantially all space between the body 10 and/or housing 12 and the open ends 34. As may be seen in FIG. 3, the sealant 40 encompasses the first electrical lead 18 and the second electrical lead 20 and fills space between the first electrical lead 18 and the second electrical lead 20 and the wall 32, thereby sealing the body 10 within the sheath 30.

The sealant 40 may be any material capable of sealing the open ends 34, and may include materials that remain flexible at desired operating temperatures, as well as materials that harden as long as such materials do not become brittle. Materials that retain some flexibility in the range of anticipated operating temperatures may maintain a more durable, longer lasting seal. Regardless of the material used as the sealant 40, the material should be a material that initially flows well into the open ends 34 without substantial voids or holes being created, and should be able to flow well into the open ends 34 around any electrical leads present in the open ends 34 such as the first electrical lead 18 and the second electrical lead 20. Examples of suitable materials for the sealant 40 include silicone-based sealants and silicone-containing sealants. One particular example of a suitable material for the sealant 40 is RTV 162 electronic grade adhesive silicone from Momentive Performance Materials of Albany, N.Y.

As necessary, the sealant 40 may be allowed to cure once disposed in the open ends 34, and the finished product may be inspected to ensure that no significant holes or voids are present in the sealant 40 within the open ends 34. As the cost of materials to manufacture the sealed thermostat are relatively low compared to existing hermetically sealed thermostats as well as compared to the potential costs of failures of the seal (e.g. explosion and associated injury or damage), any finished products that have significant holes or voids in the sealant, as well as finished products with holes or tears in the sheath 30 can be rejected and either discarded or disassembled and the certain thermostat components (e.g. the body 10 and its associated components) reused in the manufacturing process.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

We claim:

1. A sealed thermostat comprising:
a body;
electrical leads extending from the body for electrically connecting the thermostat to a system;
a sheath sized to encapsulate the body and having a wall terminating at an open end, the sheath being disposed around the body with at least one of the electrical leads extending from the open end; and
a sealant disposed in the open end around the at least one electrical lead and between the at least one electrical lead and the wall, thereby sealing the body within the sheath.

2. A sealed thermostat as recited in claim 1, wherein the open end of the sheath is one of two open ends of the sheath, both open ends being sealed by the sealant.

3. A sealed thermostat as recited in claim 2, wherein the sheath is formed in a flexible, substantially cylindrical form by the wall.

4. A sealed thermostat as recited in claim 2, wherein the electrical leads either all extend from a single open end of the sheath or extend through both open ends of the sheath.

5. A sealed thermostat as recited in claim 2, wherein the sheath wall is seamless between the open ends.

6. A sealed thermostat as recited in claim 1, wherein the sheath is sized to snugly contain the body to facilitate heat transfer between an environment outside the sheath and the body.

7. A sealed thermostat as recited in claim 1, wherein the sleeve comprises biaxially-oriented polyethylene terephthalate.

8. A sealed thermostat as recited in claim 1, wherein the sealant is selected from the group of a silicone-based sealant and a silicone-containing sealant.

9. A sealed thermostat as recited in claim 8, wherein the sealant is adhesive.

10. A sealed thermostat as recited in claim 1, wherein the body contains a shunted bimetallic element.

11. A sealed thermostat as recited in claim 1, wherein the body contains a conductive bimetallic element.

12. A sealed thermostat as recited in claim 1, wherein the sealant and sheath substantially completely isolate the body from gasses capable of being ignited by an arc within the body.

13. A method for sealing a thermostat having a body with electrical leads for electrically connecting the thermostat to a system extending therefrom comprising:
disposing the body in a sheath sized to encapsulate the body and having a wall terminating at an open end with at least one of the electrical leads extending from the open end; and
filling the open end around the at least one electrical lead and between the at least one electrical lead and the wall with a sealant, thereby sealing the body within the sheath.

14. A method as recited in claim 13, further comprising curing the sealant.

15. A method as recited in claim 14, further comprising inspecting the sealant after curing to detect any holes or voids in the sealant.

16. A method as recited in claim 13, further comprising sizing the sleeve to substantially snugly receive the body.

17. A method as recited in claim 13, wherein the open end of the sheath is one of two open ends of the sheath and wherein filling the open end with the sealant comprises filling both open ends of the sheath with the sealant.

18. A method as recited in claim 13, wherein filling the open end with the sealant comprises ensuring that the sealant completely closes the open end around any electrical leads within the open end.

19. A method as recited in claim 13, wherein the sealant is an adhesive silicone.

20. A method as recited in claim 13, wherein filling the open end with the sealant comprises ensuring that sealant fills all locations of the open end with at least a minimum thickness of the sealant.
